(19) United States
(12) Patent Application Publication
(10) Pub. No.: US 2023/0403537 A1
(43) Pub. Date: Dec. 14, 2023

(54) Hybrid Automatic Repeat Request Procedures for Multimedia Broadcast and Multicast Services

(71) Applicant: GOOGLE LLC, Mountain View, CA (US)

(72) Inventor: Kao-Peng Chou, Taoyuan City (TW)

(21) Appl. No.: 18/250,356

(22) PCT Filed: Oct. 20, 2021
(86) PCT No.: PCT/US21/55808

§ 371 Date: Apr. 24, 2023

Related U.S. Application Data
(60) Provisional application No. 63/119,025, filed on Nov. 30, 2020.
(60) Provisional application No. 63/198,493, filed on Oct. 22, 2020.

(51) Int. Cl. H04W 4/06

(52) U.S. Cl. CPC H04W 4/06

(57) ABSTRACT

A method in a user equipment (UE) for managing reception of multicast and/or broadcast services (MBS) includes transmitting (702) an MBS interest indication to a base station corresponding to an MBS service of interest. The method also includes receiving (704) an acknowledgement of the MBS interest indication from the base station. Further, the method includes starting (706) to provide feedback related to the MBS service in response to receiving the acknowledgement.

### FIELD OF THE DISCLOSURE

This disclosure relates to wireless communications and, more particularly, to feedback and retransmission mechanisms for multicast and/or broadcast services (MBS).

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP layer defined for the Evolved Universal Terrestrial Radio Access (EUTRA) radio interface (see 3GPP specification TS 36.323) and New Radio (NR) (see 3GPP specification TS 38.323) provides sequencing of protocol data units (PDUs) in the uplink direction (from a user device, also known as a user equipment (UE), to a base station) as well as in the downlink direction (from the base station to the UE). Further, the PDCP sublayer provides services for signaling radio bearers (SRBs) to the Radio Resource Control (RRC) sublayer. The PDCP sublayer also provides services for data radio bearers (DRBs) to a Service Data Adaptation Protocol (SDAP) sublayer or a protocol layer such as an Internet Protocol (IP) layer, an Ethernet protocol layer, and an Internet Control Message Protocol (ICMP) layer. Generally speaking, the UE and a base station can use SRBs to exchange RRC messages as well as non-access stratum (NAS) messages, and can use DRBs to transport data on a user plane.

The UE in some scenarios can concurrently utilize resources of multiple nodes (e.g., base stations or components of a distributed base station or disaggregated base station) of a radio access network (RAN), interconnected by a backhaul. When these network nodes support different radio access technologies (RATs), this type of connectivity is referred to as Multi-Radio Dual Connectivity (MR-DC). When operating in MR-DC, the cell(s) associated with the base station operating as a master node (MN) define a master cell group (MCG), and the cells associated with the base station operating as a secondary node (SN) define the secondary cell group (SCG). The MCG covers a primary cell (PCell) and zero, one, or more secondary cells (SCells), and the SCG covers a primary secondary cell (PSCell) and zero, one, or more SCells. The UE communicates with the MN (via the MCG) and the SN (via the SCG). In other scenarios, the UE utilizes resources of one base station at a time, i.e., single connectivity (SC). The UE in SC only communicates with the MN (via the MCG). One base station and/or the UE determines that the UE should establish a radio connection with another base station. For example, one base station can determine to hand the UE over to the second base station, and initiate a handover procedure. The UE in other scenarios can concurrently utilize resources of a RAN node (e.g., a single base station or a component of a distributed base station or a disaggregated base station), interconnected by a backhaul.

UEs can use several types of SRBs and DRBs. So-called SRB1 resources carry RRC messages, which in some cases include NAS messages over the dedicated control channel (DCCH), and SRB2 resources support RRC messages that include logged measurement information or NAS messages, also over the DCCH but with lower priority than SRB1 resources. More generally, SRB1 and SRB2 resources allow the UE and the MN to exchange RRC messages related to the MN and embed RRC messages related to the SN, and also can be referred to as MCG SRBs. SRB3 resources allow the UE and the SN to exchange RRC messages related to the SN, and can be referred to as SCG SRBs. Split SRBs allow the UE to exchange RRC messages directly with the MN via lower layer resources of the MN and the SN. Further, DRBs terminated at the MN and using the lower-layer resources of only the MN can be referred as MCG DRBs, DRBs terminated at the SN and using the lower-layer resources of only the SN can be referred as SCG DRBs, and DRBs terminated at the MCG but using the lower-layer resources of the MN, the SN, or both the MN and the SN can be referred to as split DRBs.

UEs can perform handover procedures to switch from one cell to another, whether in single connectivity (SC) or DC operation. These procedures involve messaging (e.g., RRC signaling and preparation) among RAN nodes and the UE. The UE may handover from a cell of a serving base station to a target cell of a target base station, or from a cell of a first distributed unit (DU) of a serving base station to a target cell of a second DU of the same base station, depending on the scenario. In DC scenarios, UEs can perform PSCell change procedures to change PSCells. These procedures involve messaging (e.g., RRC signaling and preparation) among RAN nodes and the UE. The UE may perform PSCell change from a PSCell of a serving SN to a target PSCell of a target SN, or from a PSCell of a source DU of a base station to a PSCell of a target DU of the same base station, depending on the scenario.

Base stations that operate according to fifth-generation (5G) New Radio (NR) requirements support significantly larger bandwidth than fourth-generation (4G) base stations. Accordingly, the Third Generation Partnership Project (3GPP) has proposed that for Release 15, user equipment units (UEs) support a 100 MHz bandwidth in frequency range 1 (FR1) and a 400 MHz bandwidth in frequency range (FR2). Due to the relatively wide bandwidth of a typical carrier, 3GPP has proposed that for Release 17, a 5G NR base station can provide multicast and/or broadcast services (MBS) (also referred to as multimedia broadcast/multicast services (MBMS)) to UEs that can be useful in many content delivery applications, such as transparent IPv4/IPv6 multicast delivery, IPTV, software delivery over wireless, group communications, IoT applications, V2X applications, and emergency messages related to public safety.

3GPP seeks to improve reliability of MBS for UEs. However, it is not clear how the UE is to report feedback (e.g., hybrid automatic repeat request (HARQ) feedback) regarding MBS transmissions to the RAN, especially in scenarios where the UE switches between MBS services or consumes multiple MBS services concurrently.

### SUMMARY

A UE and/or a base station can implement the techniques of this disclosure for managing reception and transmission of MBS services. A UE can transmit an MBS interest information message to a base station to indicate an MBS service in which the UE is interested. For example, the MBS interest information message may include a temporary mobile group identity (TMGI) that identifies the MBS service. In response, the base station can transmit an MBS interest confirm message to the UE. After receiving the MBS interest confirm message, the UE can start to provide feedback (e.g., HARQ feedback) related to the MBS service. After transmitting the MBS interest confirm message to the UE, the base station expects received feedback to be for the MBS service, and processes the feedback accordingly.

By waiting to provide feedback related to the MBS service until the UE receives the MBS interest confirm message, the UE prevents scenarios in which the base station misattributes received feedback to the incorrect MBS service or fails to decode received feedback. For example, the UE may receive a first MBS service and transmit the MBS interest information message to indicate that the UE is interested in switching to a second MBS service. On the other hand, if the UE does not implement these techniques, and begins to transmit feedback to the base station prior to receiving an MBS confirm message, the base station may be unaware that the feedback relates to the second MBS service. As a result, the base station may retransmit data related to the first MBS service that the UE is no longer interested in receiving. In contrast, using the techniques of this disclosure, the UE waits to transmit feedback related to reception of the second MBS service until the UE receives the MBS interest confirm message. The base station can then process feedback received after transmitting the MBS interest confirm message as feedback for the second MBS service rather than the first MBS service.

The UE can handle information (e.g., control information and/or data) received after transmitting the MBS interest information message and before receiving the MBS interest confirm message in a variety of ways. In some implementations, the UE can start monitoring for information associated with the MBS service in response to transmitting the MBS interest information message and before receiving the MBS interest confirm message. The UE can receive the information without providing feedback to the base station. In other implementations, the UE can start monitoring for information associated with the MBS service after receiving the MBS interest confirm message. The base station can scramble a cyclic redundancy check (CRC) attachment using a group radio network temporary identifier (G-RNTI) associated with the MBS service to indicate to the UE that the information relates to the MBS service.

In some implementations, the UE determines to switch to a second MBS service, and transmits a second MBS interest information message to indicate the change in UE interest. In such implementations, the UE can either continue to monitor or stop monitoring for information related to the first MBS service in response to transmitting the second MBS interest information message. Upon receiving the MBS interest confirm message, the UE can stop monitoring for information for the first MBS service.

If the UE does not receive an MBS interest confirm message, the UE can determine whether to retransmit the MBS interest information message. For example, the UE can start a timer in response to transmitting the MBS interest information message and can retransmit the MBS interest information if the timer expires before the UE receives an MBS interest confirm message. As another example, in scenarios where the UE transmits a second MBS interest information message but does not receive a second MBS interest confirm message, the UE can transmit a negative acknowledgement to the base station in response to receiving data for the first MBS service. If the base station responds by retransmitting the data to the UE in unicast, the UE can identify that the base station did not receive the MBS interest information message and retransmit the message. The UE can identify whether the data will be sent in unicast by, for example, descrambling a CRC attachment for control information related to the data using a cell RNTI (C-RNTI) of the UE rather than a G-RNTI. Alternatively, the base station can start a negative acknowledgement counter in response to receiving a negative acknowledgement for the first MBS service, and can transmit an MBS interest request to the UE to request updated MBS interest information in response to the counter exceeding a threshold.

In some implementations, the UE may indicate in the MBS interest information message multiple MBS services that the UE is interested in receiving concurrently. The UE can transmit feedback for the MBS services multiplexed on the same uplink resource (e.g., a Physical Uplink Control Channel (PUCCH) resource). In some scenarios, the UE transmits negative acknowledgements for more than one MBS service and receives retransmissions from the base station. If the base station and/or UE utilize existing HARQ feedback mechanisms for the retransmissions, HARQ feedback collisions can occur and the UE may be unable to identify to which MBS service a retransmission corresponds. However, the techniques of this disclosure enable the UE to identify which MBS service is associated with which retransmission. As one example, in some implementations, there is only a particular MBS service of the multiple MBS services that can be retransmitted in unicast (e.g., because the particular MBS service is the highest priority MBS service). If the UE receives a retransmission via unicast, the UE can identify the retransmission as related to the particular MBS service. As another example, the base station can include a field identifying the MBS service in control information for the retransmission. As yet another example, the base station can calculate slot indices for retransmissions of each respective MBS service according to a formula that is also known by the UE. The UE can therefore identify the MBS service based on the resources on which the UE receives the retransmission.

One example embodiment of these techniques is a method implemented in a UE for managing reception of MBS. The method can be executed by processing hardware and includes transmitting, to a base station, an MBS interest indication corresponding to an MBS service of interest. The method also includes receiving an acknowledgement of the MBS interest indication from the base station and, in response to receiving the acknowledgement, starting to provide feedback related to the MBS service.

Another example embodiment of these techniques is a UE including processing hardware and configured to implement the method above.

A further example embodiment of these techniques is a method implemented in a base station for managing transmission of MBS. The method can be executed by processing hardware and includes receiving, from a UE, an MBS interest indication corresponding to an MBS service of interest. The method also includes transmitting an acknowledgement of the MBS interest indication to the UE, and, in response to transmitting the acknowledgement, starting to process feedback received from the UE related to the MBS service.

Yet another example embodiment of these techniques is a base station including processing hardware and configured to implement the method above.

### BRIEF DESCRIPTION OF THE DRAWINGS

FIG. 1 is a block diagram of an example system in which a base station of a radio access network (RAN) and a user equipment (UE) can implement the techniques of this disclosure for managing reception of MBS services;

FIG. 2 is a block diagram of an example protocol stack according to which the UE of FIG. 1 communicates with base stations;

FIG. 3A is a messaging diagram of an example scenario in which a UE transmits an MBS interest information message to a base station and starts providing HARQ feedback for an MBS service in response to receiving an MBS interest confirm message from the base station;

FIG. 3B is a messaging diagram of an example scenario similar to the scenario of FIG. 3A, but where the UE switches to receiving a second MBS service after receiving the first MBS service;

FIG. 3C is a messaging diagram of an example scenario to the scenario of FIG. 3B, but where the UE fails to successfully decode data for the second MBS service and transmits a negative acknowledgement to the base station in response;

FIG. 4A is a messaging diagram of an example scenario in which a UE transmits an MBS interest information message to a base station to switch from a first MBS service to a second MBS service, and, in response, stops monitoring for control information for the first MBS service and starts monitoring for control information for the second MBS service without starting HARQ feedback;

FIG. 4B is a messaging diagram of an example scenario similar to the scenario of FIG. 4A, but where the UE stops monitoring for control information for the first MBS service and does not start monitoring for control information for the second MBS service until after receiving an MBS interest confirm message from the base station;

FIG. 4C is a messaging diagram of an example scenario similar to the scenario of FIG. 4A, but where the UE does not stop monitoring for control information for the first MBS service until after receiving an MBS interest confirm message from the base station;

FIG. 5A is a messaging diagram of an example scenario in which a UE retransmits an MBS interest information message to a base station in response to a timer expiring before the UE receives an MBS interest confirm message;

FIG. 5B is a messaging diagram of an example scenario in which a UE retransmits an MBS interest information message to a base station in response to receiving a unicast retransmission of a first MBS service after the UE has transmitted an MBS interest information message;

FIG. 5C is a messaging diagram of an example scenario in which a UE retransmits an MBS interest information message to a base station in response to receiving an MBS interest request message from the base station;

FIG. 6A is messaging diagram of an example scenario in which a UE transmits an MBS interest information message to a base station that indicates three MBS services that the UE is interested in receiving and transmits multiplexed HARQ feedback for the three MBS services on a single PUCCH resource;

FIG. 6B is a messaging diagram of an example scenario similar to the scenario of FIG. 6A, where the base station retransmits data for a priority MBS service via unicast transmission;

FIG. 6C is a messaging diagram of an example scenario similar to the scenario of FIG. 6A, where the base station indicates which of the three MBS services is associated with a retransmission using a field in control information the base station transmits to the UE;

FIG. 6D is a messaging diagram of an example scenario similar to the scenario of FIG. 6A, where the base station uses a formula to determine which resources to use for retransmissions for MBS services;

FIG. 7 is a flow diagram of an example method for managing reception of MBS services, which can be implemented in a UE of this disclosure; and

FIG. 8 is a flow diagram of an example method for managing transmission of MBS services, which can be implemented in a base station of this disclosure.

### DETAILED DESCRIPTION OF THE DRAWINGS

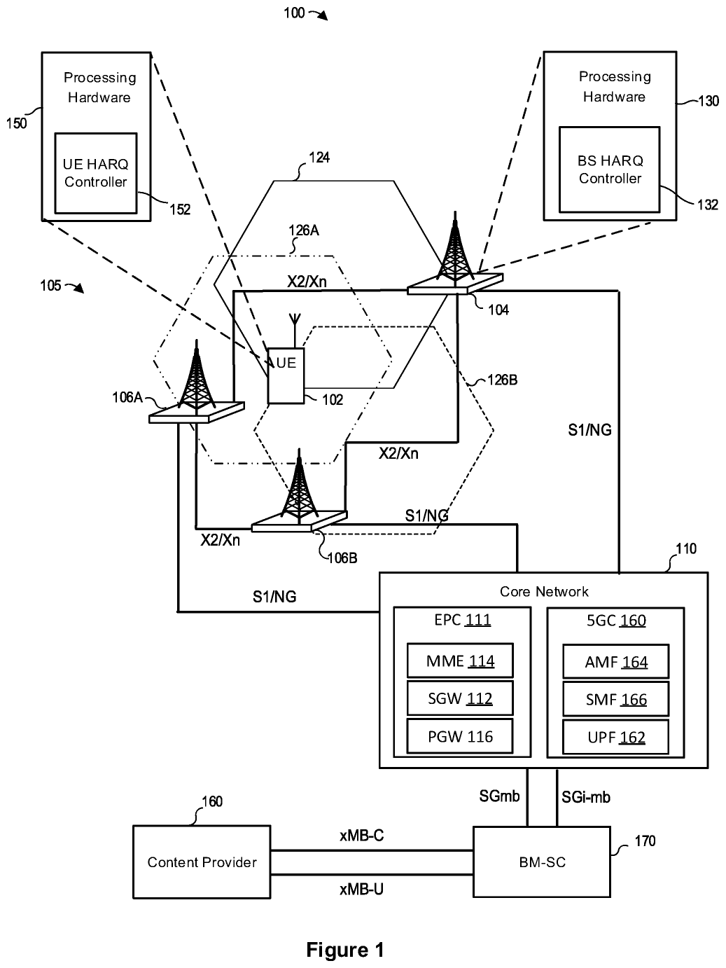

FIG. 1 depicts an example wireless communication system 100 that can implement the techniques of this disclosure. The wireless communication system 100 includes a UE 102, as well as base stations 104, 106A, 106B of a radio access network (RAN) (e.g., RAN 105) that are connected to a core network (CN) 110. The base stations 104, 106A, 106B can be any suitable type, or types, of base stations, such as an evolved node B (eNB), a next-generation eNB (ng-eNB), or a 5G Node B (gNB), for example. As a more specific example, the base station 104 can be an eNB or a gNB, and the base stations 106A and 106B can be gNBs.

The base station 104 supports a cell 124, the base station 106A supports a cell 126A, and the base station 106B supports a cell 126B. The cell 124 partially overlaps with both of cells 126A and 126B, such that the UE 102 can be in range to communicate with base station 104 while simultaneously being in range to communicate with base station 106A or 106B (or in range to detect or measure the signal from both base stations 106A and 106B). The overlap can make it possible for the UE 102 to hand over between cells (e.g., from cell 124 to cell 126A or 126B) or base stations (e.g., from base station 104 to base station 106A or base station 106B) before the UE 102 experiences radio link failure, for example. Moreover, the overlap allows the various dual connectivity (DC) scenarios discussed below. For example, the UE 102 can communicate in DC with the base station 104 (operating as an MN) and the base station 106A (operating as an SN) and, upon completing a handover to base station 106B, can communicate with the base station 106B (operating as an MN). As another example, the UE 102 can communicate in DC with the base station 104 (operating as an MN) and the base station 106A (operating as an SN) and, upon completing an SN change, can communicate with the base station 104 (operating as an MN) and the base station 106B (operating as an SN).

More particularly, when the UE 102 is in DC with the base station 104 and the base station 106A, the base station 104 operates as a master eNB (MeNB), a master ng-eNB (Mng-eNB), or a master gNB (MgNB), and the base station 106A operates as a secondary gNB (SgNB) or a secondary ng-eNB (Sng-eNB).

In non-MBS (i.e., unicast) operation, the UE 102 can use a radio bearer (e.g., a DRB or an SRB) that at different times terminates at an MN (e.g., the base station 104) or an SN (e.g., the base station 106A). For example, after handover or SN change to the base station 106B, the UE 102 can use a radio bearer (e.g., a DRB or an SRB) that at different times terminates at the base station 106B. The UE 102 can apply one or more security keys when communicating on the radio bearer, in the UL (from the UE 102 to a base station) and/or DL (from a base station to the UE 102) direction. In the non-MBS operation, the UE 102 transmits data via the radio bearer on (i.e., within) an uplink BWP of a cell to the base station and/or receives data via the radio bearer on a DL BWP of the cell from the base station. The UL BWP can be an initial UL BWP or a dedicated UL BWP, and the DL BWP can be an initial DL BWP or a dedicated DL BWP. The UE 102 can receive paging, system information, public warning message(s), or a random access response on the DL BWP. In such non-MBS operation, the UE 102 can be in a connected state. Alternatively, the UE 102 can be in an idle or inactive state if the UE 102 supports small data transmission in the idle or inactive state.

In MBS operation, the UE 102 can use a radio bearer (e.g., a DRB or an MRB) that at different times terminates at an MN (e.g., the base station 104) or an SN (e.g., the base station 106A). For example, after handover or SN change to the base station 106B, the UE 102 can use a radio bearer (e.g., a DRB or an MRB) that at different times terminates at the base station 106B which can be an MN or SN. The base station can utilize the radio bearer to transmit application-level messages, such as security keys, to the UE 102. In some implementations, the base station (e.g., the MN or SN) can transmit MBS data over dedicated radio resources (i.e., the radio resources dedicated to the UE 102) to the UE 102 (e.g., via the DRB or MRB). In such implementations, the base station can apply one or more security keys to protect integrity of MBS data and/or encrypt MBS data and transmits the encrypted and/or integrity protected MBS data over the dedicated radio resources to the UE 102. Correspondingly, the UE 102 can apply the one or more security keys to decrypt MBS data and/or check integrity of the MBS data when receiving the MBS data on the radio bearer, in the downlink (from a base station to the UE 102) direction. In other implementations, the base station (e.g., the MN or SN) can transmit MBS data over common radio resources (i.e., the radio resources common to the UE 102 and other UE(s)) or an MBS DL BWP of a cell from the base station to the UE 102 (e.g., via the DRB or MRB). In such implementations, the base station can refrain from applying a security key to MBS data and transmit the MBS data on the radio bearer. Correspondingly, the UE 102 can omit applying a security key to MBS data received on the radio bearer.

The base station 104 includes processing hardware 130, which can include one or more general-purpose processors (e.g., central processing units (CPUs)) and a computer-readable memory storing machine-readable instructions executable on the one or more general-purpose processor(s), and/or special-purpose processing units. The processing hardware 130 in the example implementation in FIG. 1 includes a base station hybrid automatic repeat request (HARQ) controller 132 that is configured to support the techniques of this disclosure, discussed below. While not shown in FIG. 1, the base stations 106A and 106B may include processing hardware similar to the processing hardware 130.

The UE 102 includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1 includes a UE HARQ controller 152 that is configured to support the techniques of this disclosure, discussed below.

The CN 110 can be an evolved packet core (EPC) 111 or a fifth-generation core (5GC) 160, both of which are depicted in FIG. 1. The base station 104 can be an eNB supporting an S1 interface for communicating with the EPC 111, an ng-eNB supporting an NG interface for communicating with the 5GC 160, or a gNB that supports an NR radio interface as well as an NG interface for communicating with the 5GC 160. The base station 106A can be an EUTRA-NR DC (EN-DC) gNB (en-gNB) with an S1 interface to the EPC 111, an en-gNB that does not connect to the EPC 111, a gNB that supports the NR radio interface and an NG interface to the 5GC 160, or a ng-eNB that supports an EUTRA radio interface and an NG interface to the 5GC 160. To directly exchange messages with each other during the scenarios discussed below, the base stations 104, 106A, and 106B can support an X2 or Xn interface.

Among other components, the EPC 111 can include a Serving Gateway (SGW) 112, a Mobility Management Entity (MME) 114, and a Packet Data Network Gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. The UPF 162 is generally configured to transfer user-plane packets related to audio calls, video calls, Internet traffic, etc., the AMF 164 is configured to manage authentication, registration, paging, and other related functions, and the SMF 166 is configured to manage PDU sessions. The UPF 162, AMF 164 and/or the SMF 166 can be configured to support MBS. For example, the SMF 166 can be configured to manage or control MBS transport, configure the UPF 162 and/or RAN 105 for MBS flows, and/or manage or configure MBS session(s) or PDU Session(s) for MBS for UE 102. The UPF 162 is configured to transfer MBS data packets to audio, video, Internet traffic, etc. to the RAN 105. The UPF 162 and/or SMF 166 can be configured for both unicast service and MBS, or for MBS only.

Generally, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies such as sixth generation (6G) radio access and/or 6G core network or 5G NR-6G DC, for example.

In different configurations or scenarios of the wireless communication system 100, the base station 104 can operate as an MeNB, an Mng-eNB, or an MgNB, the base station 106B can operate as an MeNB, an Mng-eNB, an MgNB, an SgNB, or an Sng-eNB, and the base station 106A can operate as an SgNB or an Sng-eNB. The UE 102 can communicate with the base station 104 and the base station 106A or 106B via the same radio access technology (RAT), such as EUTRA or NR, or via different RATs.

When the base station 104 is an MeNB and the base station 106A is an SgNB, the UE 102 can be in EN-DC with the MeNB 104 and the SgNB 106A. When the base station 104 is an Mng-eNB and the base station 106A is an SgNB, the UE 102 can be in next generation (NG) EUTRA-NR DC (NGEN-DC) with the Mng-eNB 104 and the SgNB 106A. When the base station 104 is an MgNB and the base station 106A is an SgNB, the UE 102 can be in NR-NR DC (NR-DC) with the MgNB 104 and the SgNB 106A. When the base station 104 is an MgNB and the base station 106A is an Sng-eNB, the UE 102 can be in NR-EUTRA DC (NE-DC) with the MgNB 104 and the Sng-eNB 106A.

As will be described in further detail below, a content provider 160 provides MBS services to the UE 102 via the RAN 105. In particular, the content provider 160 can communicate data and control information with a network broadcast/multicast service center (BM-SC) 170 over an xMB interface (also referred to as an xMB reference point). The xMB interface may include an xMB-C interface and an xMB-U interface for control plane and user plane signaling, respectively. Further, the BM-SC may exchange data and control information with the CN 110 over an SGi-mb interface and an SGmb interface, respectively. The SGi-mb and SGmb interfaces may connect the BM-SC 170 to gateways of the CN 110, such that the content provider 160 can provide services to the UE 102 via the CN 110 and the RAN 105.

MBS utilizes a point to multipoint (PTM) transmission mechanism that enables a base station (e.g., the base station 104) to transmit MBS-related control information and data to the UE 102 and other UEs on shared downlink radio resources. In LTE Release 13, 3GPP introduced Single-Cell PTM (SC-PTM), which utilizes cell-specific PDSCH resources. For example, the base station 104 can utilize a Single-Cell Multicast Traffic Channel (SC-MTCH) and a Single-Cell Multicast Control Channel (SC-MCCH) to deliver user and control plane data, respectively. The base station 104 can broadcast SC-PTM configuration information via the SC-MCCH. The SC-PTM configuration information provides information regarding available MBS services. Each MBS service is associated with a temporary mobile group identity (TMGI), which the UE 102 can use to identify the MBS service at the network and application layers. Further, each MBS service is also associated with a group radio network temporary identifier (G-RNTI), such that there is a one-to-one mapping between a G-RNTI and a TMGI. The SC-PTM configuration information includes the G-RNTI and indicates the associated TMGI. For example, the base station 104 can generate the G-RNTI and wrap the G-RNTI and the associated TMGI in an RRC information element in the SC-PTM configuration information.

More generally, a G-RNTI is an example of an MBS-RNTI, and SC-PTM configuration information is an example of MBS configuration information. The base station 104 can transmit an MBS-RNTI to the UE 102 (e.g., within MBS configuration information) so that when the base station 104 later transmits MBS-related information to the UE 102 can utilize the MBS-RNTI for decoding purposes. Thus, the UE 102 can receive MBS services that the UE 102 is interested in by monitoring for control information (e.g., Downlink Control Information (DCI) including cyclic redundancy check (CRC) attachments scrambled with the G-RNTI. The UE 102 can identify the MBS service by determining the TMGI associated with the G-RNTI.

To provide a new MBS service, the content provider 160 can request a TMGI from the BM-SC 170. The content provider 160 or the BM-SC 170 sends a user service description (USD) to the UE 102 (e.g., via broadcast or multicast using service announcement procedures). The USD includes the TMGI, broadcasting area, time session, and frequency band of each MBS service. The BM-SC 170 also sends TMGIs to the UE 102 via the base station 104. The base station 104 transmits (e.g., in broadcast or multicast) the MBS services to UEs. The UE 102 can receive and switch between MBS services independently from the base station 104 provided the UE 102 has received the TMGI and G-RNTI associated with the MBS service.

While the discussion above refers to the BM-SC 170, the functionality of the BM-SC 170 relevant to this disclosure may be integrated into a new 5GC function or 5GC functions such as the session management function (SMF), user plane function (UPF), etc.

The UE 102 can indicate MBS services that the UE 102 is interested in receiving in a variety of ways. In some scenarios, the base station 104 and the UE 102 can perform an MBS counting procedure. The base station 104 sends an request (e.g., an MBMSCountingRequest message) to the UE 102 that includes a list of MBMS services (e.g., TMGIs). The UE 102 can respond with a response message (e.g., an MBMSCountResponse message) indicating an MBS service that the UE is receiving via an MBS radio bearer (MRB) or interested in receiving. If the UE 102 is interested in receiving an MBS that is not broadcasted in the cell, the base station 104 can inform the BM-SC 170 to activate transmission of the MBS service. The base station 104 can configure the UE 102 with TMGIs and G-RNTIs in advance. Accordingly, if an MBMS service is being broadcast in the cell that the UE 102 is connected to, the UE 102 can consume the service without explicitly indicating the UE interest in the response message.

In other scenarios, the base station 104 and the UE 102 can perform an MBS interest indication procedure. The base station 104 can broadcast information regarding available MBS services (e.g., broadcast frequency band, time session, service identifiers such as TMGIs) in system information (e.g., SIB15). The UE 102 can inform the base station 104 of services in which the UE 102 is interested by sending an MBS interest indication (e.g., a MBMSInterestIndication message) to the base station 104.

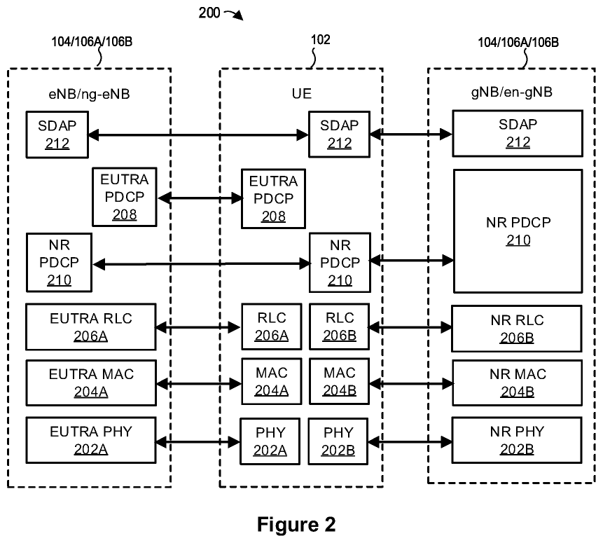

FIG. 2 illustrates, in a simplified manner, an example protocol stack 200 according to which the UE 102 can communicate with an eNB/ng-eNB or a gNB (e.g., one or more of the base stations 104, 106A, 106B).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to the EUTRA PDCP sublayer 208 and, in some cases, to the NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides RLC channels to the NR PDCP sublayer 210. The UE 102, in some implementations, supports both the EUTRA and the NR stack as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and an SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets”. The packets can be MBS packets or non-MBS packets. For example, the MBS packets include MBS data packets including application content for an MBS service (e.g., IPv4/IPv6 multicast delivery, IPTV, software delivery over wireless, group communications, IoT applications, V2X applications, and/or emergency messages related to public safety). In another example, the MBS packets include application control information for the MBS service.

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

In scenarios where the UE 102 operates in EN-DC with the base station 104 operating as an MeNB and the base station 106A operating as an SgNB, the wireless communication system 100 can provide the UE 102 with an MN-terminated bearer that uses EUTRA PDCP sublayer 208, or an MN-terminated bearer that uses NR PDCP sublayer 210. The wireless communication system 100 in various scenarios can also provide the UE 102 with an SN-terminated bearer, which uses only the NR PDCP sublayer 210. The MN-terminated bearer can be an MCG bearer or a split bearer. The SN-terminated bearer can be an SCG bearer or a split bearer. The MN-terminated bearer can be an SRB (e.g., SRB1 or SRB2) or a DRB. The SN-terminated bearer can be an SRB or a DRB.

In some implementations, a base station (e.g., base station 104, 106A or 106B) broadcasts MBS data packets via one or more MBS radio bearers (MRB(s)), and in turn the UE 102 receives the MBS data packets via the MRB(s). The base station can include configuration(s) of the MRB(s) in multicast configuration parameters (which can also be referred to as MBS configuration parameters). In some implementations, the base station broadcasts the MBS data packets via RLC sublayer 206, MAC sublayer 204, and PHY sublayer 202, and correspondingly, the UE 102 uses PHY sublayer 202, MAC sublayer 204, and RLC sublayer 206 to receive the MBS data packets. In such implementations, the base station and the UE 102 may not use PDCP sublayer 208 and a SDAP sublayer 212 to communicate the MBS data packets. In other implementations, the base station broadcasts the MBS data packets via PDCP sublayer 208, RLC sublayer 206, MAC sublayer 204, and PHY sublayer 202, and correspondingly, the UE 102 uses PHY sublayer 202, MAC sublayer 204, RLC sublayer 206 and PDCP sublayer 208 to receive the MBS data packets. In such implementations, the base station and the UE 102 may not use a SDAP sublayer 212 to communicate the MBS data packets. In yet other implementations, the base station broadcasts the MBS data packets via the SDAP sublayer 212, PDCP sublayer 208, RLC sublayer 206, MAC sublayer 204 and PHY sublayer 202, and correspondingly, the UE 102 uses PHY sublayer 202, MAC sublayer 204, RLC sublayer 206, PDCP sublayer 208, and the SDAP sublayer 212 to receive the MBS data packets.

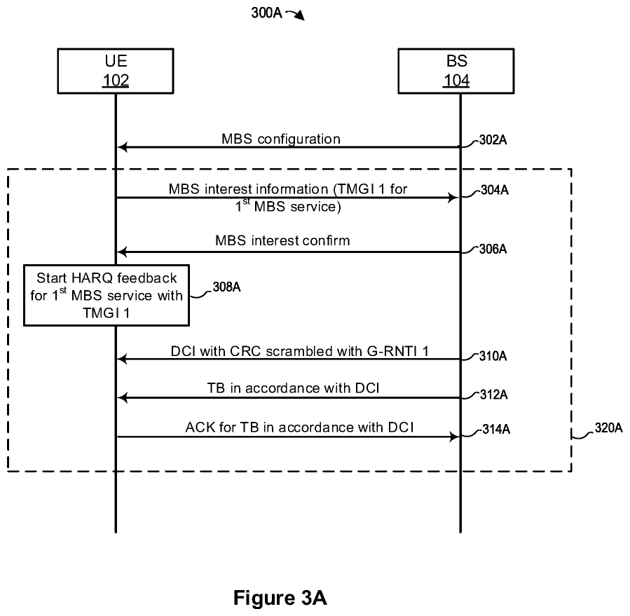

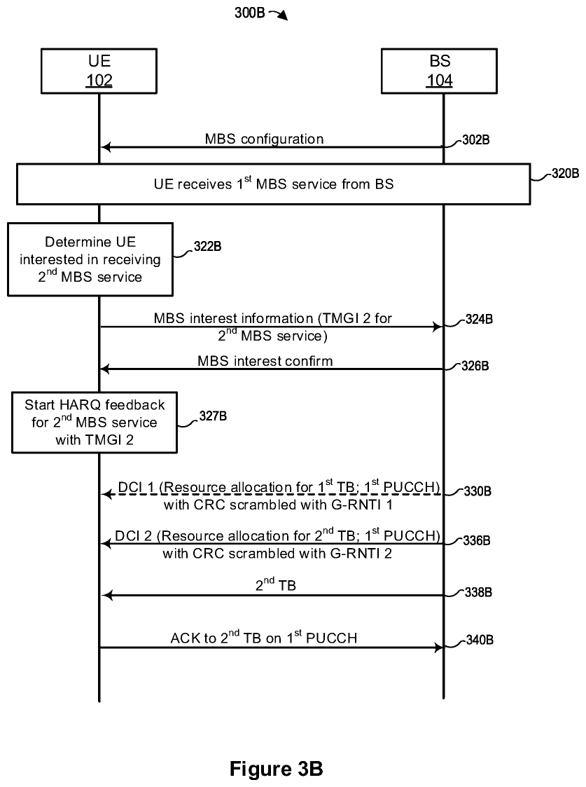

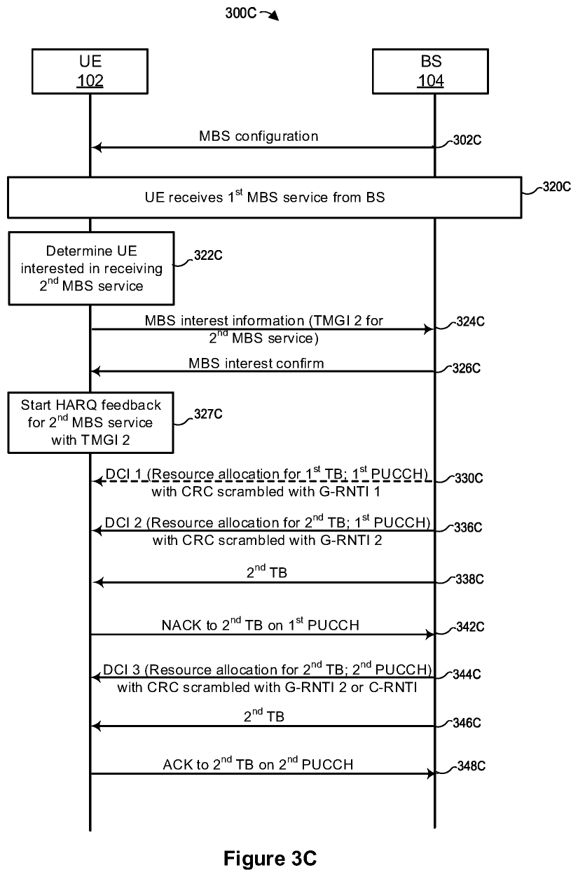

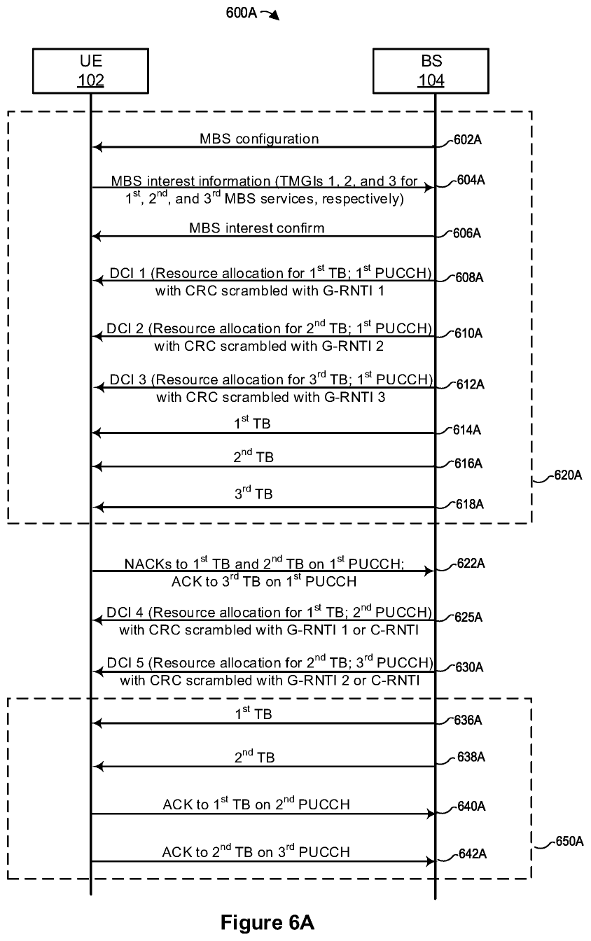

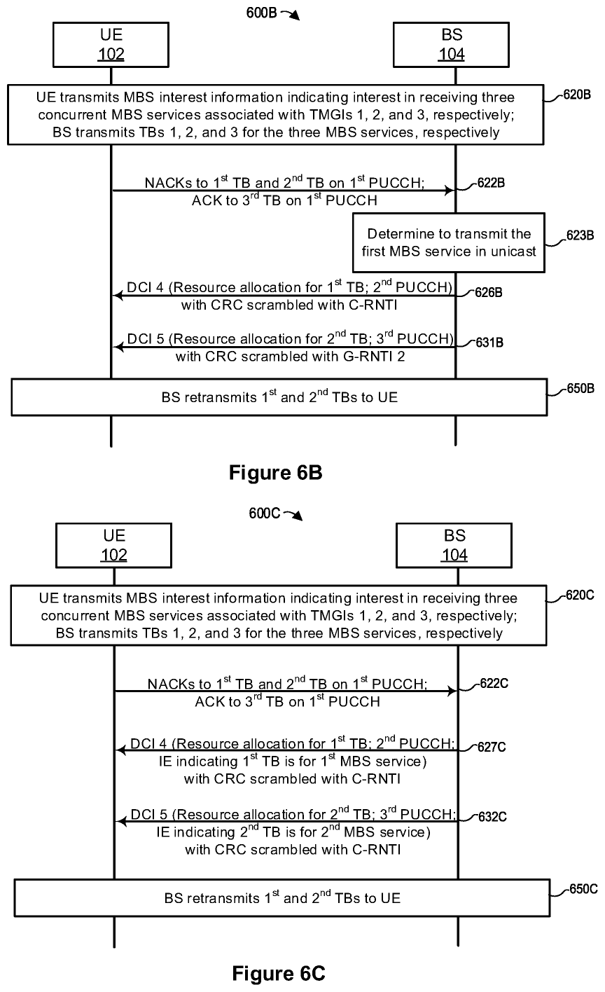

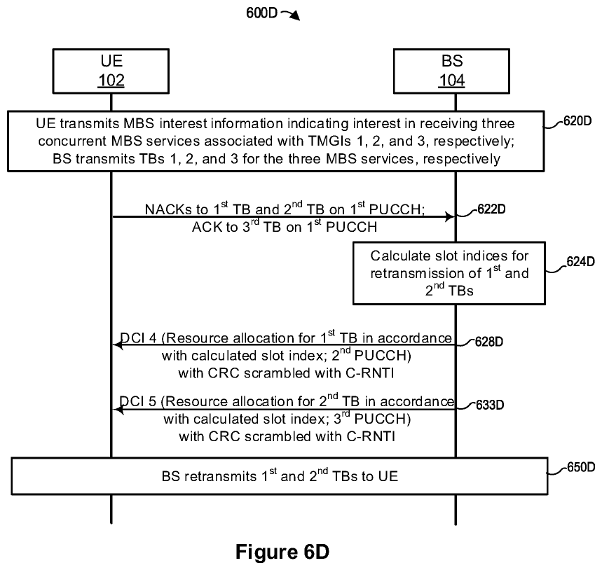

FIGS. 3A-6D are messaging diagrams of example scenarios in which a base station and UE implement the techniques of this disclosure to support feedback mechanisms for MBS services. Generally speaking, events in FIGS. 3A-5C that are similar are labeled with similar reference numbers (e.g., event 302A is similar to events 302B, 302C, 402A, 402B, etc.), and events in FIGS. 6A-6D that are similar are labeled with similar reference numbers (e.g., event 622A is similar to events 622B, 622C, 622D), with differences discussed below where appropriate. With the exception of the differences shown in the figures and discussed below, any of the alternative implementations discussed with respect to a particular event (e.g., for messaging and processing) may apply to events labeled with similar reference numbers in other figures.

Referring first to a scenario 300A illustrated in FIG. 3A, a UE 102 communicates with a base station 104. Initially, the UE 102 acquires information related to MBS services (e.g., service broadcasting time, frequency band, broadcast area, etc.) from USD metadata. In the scenario 300A, the USD describes at least two MBS services: a first MBS service and a second MBS service and includes TMGIs 1 and 2 identifying the first MBS service and the second MBS service, respectively. The base station 104 may broadcast or multicast the first MBS service and the second MBS service concurrently. However, in the scenario 300A, the UE 102 consumes only one MBS service at a time, but can switch between the first MBS service and the second MBS service. In contrast, in other scenarios, such as those discussed with reference to FIGS. 6A-6D, the UE 102 can consume multiple MBS services concurrently.

The base station 104 transmits 302A MBS configuration information (e.g., SC-PTM configuration information) to the UE 102. In the MBS configuration information, the base station 104 includes a G-RNTI 1 and a G-RNTI 2. The MBS configuration information also indicates that the G-RNTIs 1 and 2 are associated with the TMGI 1 and the TMGI 2, respectively.

To receive the first MBS service, the UE 102 transmits 304A an MBS interest information message (e.g., an MBMSInterestIndication message) to the base station 104 that includes the TMGI 1. Based on the MBS interest information message, the base station 104 determines that the UE 102 is interested in receiving the first IBS service or is receiving the first IBS service. In response to the IBS interest information message, the base station 104 transmits 306A an MBS interest confirm message to the UE 102. The MBS interest confirm message can be a RLC acknowledgment PDU, a RRC message, or a HARQ acknowledgment. Generally speaking, the confirm message can be implemented at any protocol layer. For example, the UE can send the MBS interest information message to the base station on SRB1, and the base station can send an MBS interest confirm message on SRB1.

Based on the MBS interest confirm message, the UE 102 determines that the base station 104 now supports receiving feedback (e.g., supports HARQ processes) for the first MBS service. The UE 102 can then start 308A providing HARQ feedback (i.e., positive acknowledgements (ACKs) or negative acknowledgements (NACKs) in response to downlink transmissions related to the first MBS service. In the scenario 300A, the base station 104 transmits Downlink Control Information (DCI) including an indication of the G-RNTI 1. For example, the DCI may include a CRC scrambled with the G-RNTI 1 associated with the first MBS service. In response to descrambling the CRC using the G-RNTI 1, the UE 102 identifies that the DCI is for the first IBS service.

The DCI also indicates the resources allocated (e.g., time or frequency resources allocated on a Physical Downlink Shared Channel (PDSCH)) for the UE 102 to receive a transport block (TB) for the first MIBS service, and indicates an uplink resource (e.g., time or frequency resources allocated on a PUCCH) the UE 102 can use to transmit feedback related to reception of the TB. The base station 104 transmits 312A the TB to the UE 102 in accordance with the DCI. If the UE 102 successfully receives and decodes the TB, and the UE 102 has started 308A providing HARQ feedback, the UE 102 transmits 314A an ACK for TB on the PUCCH resources indicated by the DCI.

Events 304A, 306A, 308A, 310A, 312A, and 314A are collectively referred to in this disclosure as a first MBS service reception procedure 320A.

Turning to FIG. 3B, a scenario 300B is similar to the scenario 300A, except that the UE 102 determines that the UE 102 is interested in receiving a second MBS service. In particular, after a first MBS service reception procedure 320B, which is similar to the first MIBS reception procedure 320A, the UE 102 determines 322B that the UE 102 is interested in switching to receiving a second MIBS service. The UE 102 transmits 324B an MIBS interest information message including the TMGI 2 to the base station 104. In response, the base station 104 transmits 326B an MBS interest confirm message to the UE 102. Based on the MBS interest confirm message, the UE determines that the base station now supports receiving feedback for the second MBS service. Thus, the UE can start 327B to send HARQ feedback (e.g., ACK/NACK) on PUCCH resources indicated by DCIs including CRCs scrambled with the G-RNTI 2.

For example, in the scenario 300B, the base station 104 broadcasts 330B a DCI 1 with a G-RNTI 1 for the first IBS service, where this disclosure uses “with a G-RNTI 1” as a shorthand to refer to “with a CRC attachment scrambled with a G-RNTI 1.” The base station 104 also broadcasts a DCI 2 with the G-RNTI 2. The DCI 1 includes a resource allocation (e.g., a PDSCH assignment) for a first TB for the first MBS service, and a PUCCH resource indicator (i.e., a first PUCCH resource indicator) indicating resources the UE 102 can use to provide feedback for the first TB. The DCI 2 also includes a resource allocation for a second TB for the second MBS service, and a PUCCH resource indicator indicating resources the UE 102 can use to provide feedback for the second TB. In some implementations, the DCI 1 and the DCI 2 may reference the same first PUCCH resource indicator. A PUCCH resource indicator in a broadcasted DCI may be associated with distinct RRC-configured PUCCH resources of different UEs. Accordingly, different UEs with the same PUCCH resource indicator can report HARQ feedback on distinct PUCCH resources.

At a time after transmitting 324B the updated MBS interest information message, the UE stops monitoring for DCIs with the G-RNTI 1. The UE 102 therefore skips receiving the DCI 1 and does not receive the first TB. The UE 102 receives 336B the DCI 2, descrambles the CRC using the G-RNTI 2, and receives 338B the second TB in accordance with the DCI 2. Because the UE 102 has started 327B providing HARQ feedback for the second MBS service, the UE 102 sends 340B an ACK to the second TB on the first PUCCH resource in response to successfully receiving the second TB. The base station 104 can determine that the ACK received on the first PUCCH resource is for the second TB because the base station 104 previously transmitted 326B the MIBS interest confirm message.

Turning to FIG. 3C, a scenario 300C is generally similar to the scenario 300B, except that the UE 102 does not successfully receive the second TB. If the UE 102 fails to successfully receive or decode the second TB, the UE 102 sends 342C a NACK to the second TB on the first PUCCH resource. Because the base station 104 has transmitted 326C the MBS interest confirm message to the UE 102, the base station 104 can determine that the NACK received on the first PUCCH resource is for the second TB rather than for the first TB. The base station 104 responds by transmitting 344C a DCI 3 including an updated resource allocation for the second TB and a second PUCCH resource indicator to the UE 102. The DCI 3 may be sent via broadcast or multicast (i.e., the base station 104 may scramble a CRC of the DCI 3 with the G-RNTI 2), or may be sent via unicast only to the UE 102 (i.e., the base station may scramble a CRC of the DCI 3 with a cell RNTI (C-RNTI) associated with the UE 102). The base station 104 transmits 346C the second TB in accordance with the DCI 3. If the UE 102 soft combines and successfully decodes the second TB, the UE 102 sends 348C the base station 104 an ACK on the second PUCCH resource indicated by the DCI 3.

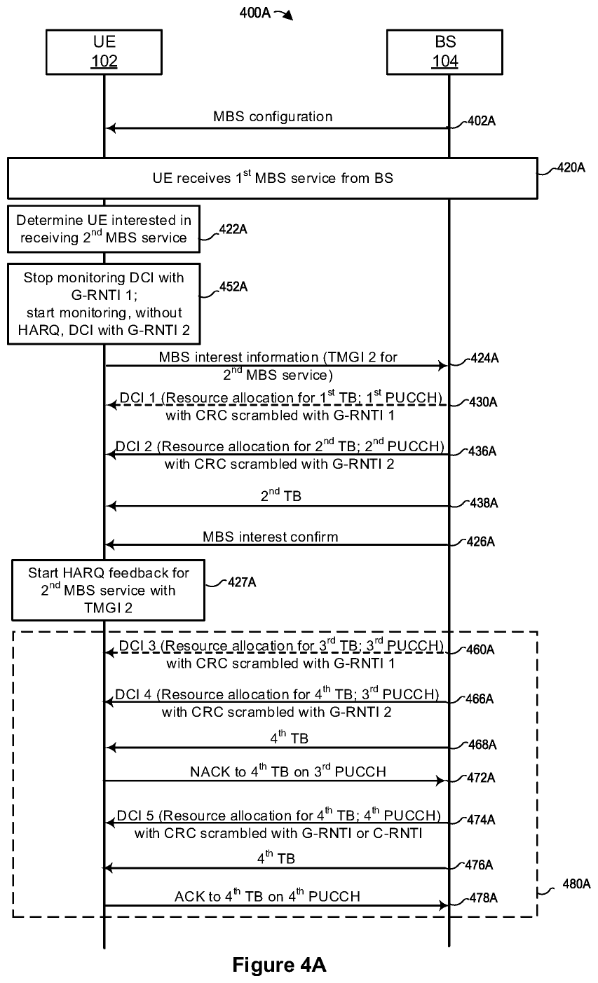

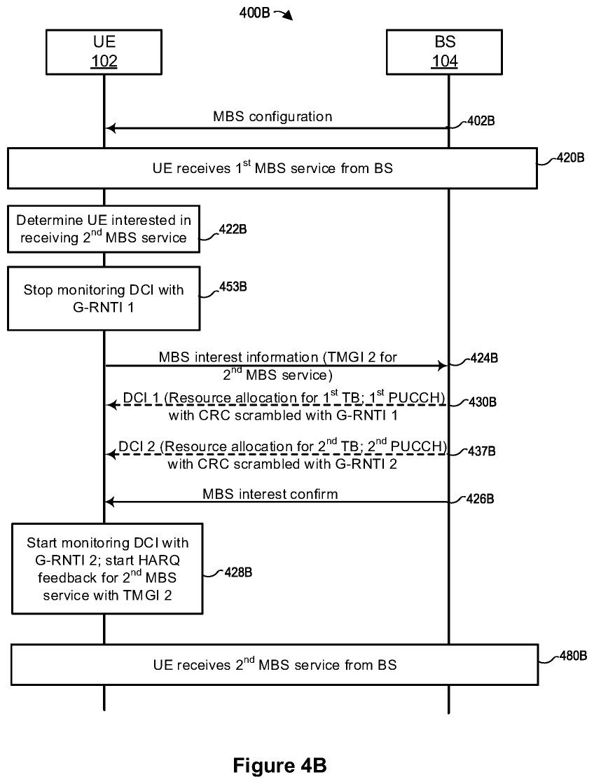

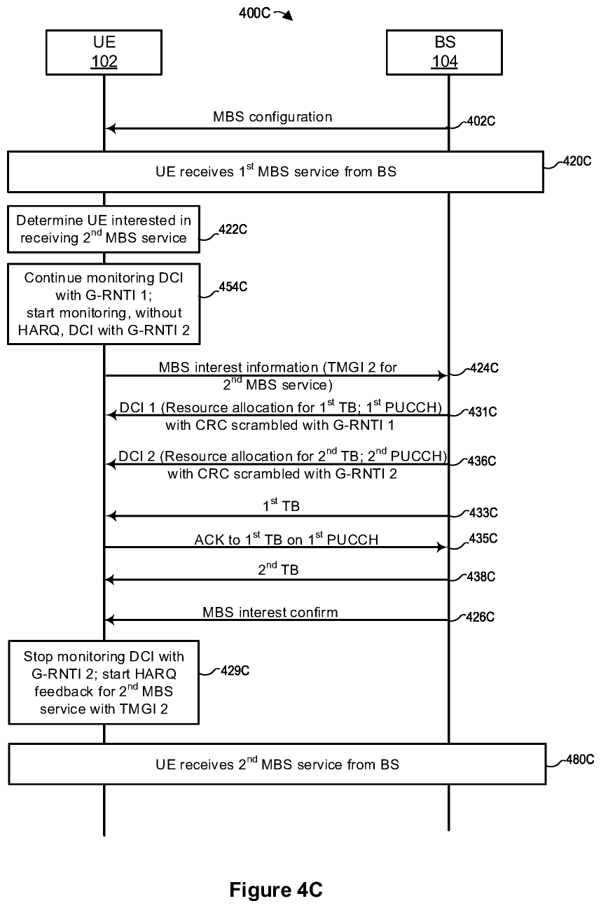

Referring next to FIGS. 4A-4C, in some scenarios, the base station 104 may transmit control information and data related to the first MBS service and/or second MBS service prior to transmitting an MBS interest confirm message. FIGS. 4A-4C illustrate ways in which the UE 102 can handle these intervening messages.

FIG. 4A illustrates a scenario 400A, which may begin similarly to the scenarios 300A-C. The UE 102 may receive 402A MBS configuration information indicating G-RNTIs 1 and 2 for the first and second MBS services and receive 420A the first MBS service from the base station 104. At a later time, the UE 102 determines 422A that the UE 102 is interested in receiving the second IBS service. In response to the determination, the UE 102 can stop 452A monitoring for DCIs with the G-RNTI 1 and start 452A monitoring for DCIs with the G-RNTI 2. While the UE 102 starts 452A monitoring for DCIs with the G-RNTI 2, and may receive TBs for the second MBS service, the UE 102 does not initially provide HARQ feedback because the UE 102 has not yet received an MBS interest confirm message.

To indicate that the UE 102 is interested in receiving the second IBS service, the UE 102 transmits 424A an MBS interest information message including the TMGI 2 for the second MBS service. After the UE 102 transmits 424A the MBS interest information message, the base station 104 broadcasts 430A a DCI 1 and broadcasts 436A a DCI 2, similar to the DCIs 1 and 2 the base station 104 broadcasts 330B and 336B. In the DCI 2, the base station 104 can include the same PUCCH resource indicator as the DCI 1, or a second PUCCH resource indicator. Because the UE stops 422A monitoring for DCIs with the G-RNTI 1, the UE 102 skips receiving the DCI 1 with the G-RNTI 1. The UE 102 receives 436A the DCI 2, descrambles the CRC using the G-RNTI 2, and receives 438A the second TB in accordance with the DCI 2. The UE 102 does not provide HARQ feedback (e.g., an ACK or NACK) to the second TB because the UE 102 has not received an MBS interest confirm message in response to the MBS interest information message.

At a later time, the base station 104 transmits 426A an MBS interest confirm message in response to the MBS interest information message the UE 102 transmits 424A. The UE 102 can then start 427A reporting HARQ feedback for the second MBS service to the base station 104. The base station 104 may transmit 460A a DCI 3 with the G-RNTI 1, where the DCI 3 includes a resource allocation for a third TB and a third PUCCH resource indicator. However, the UE 102 skips receiving the DCI 3. The base station 104 transmits 466A a DCI 4 with the G-RNTI 2, where the DCI 4 includes a resource allocation for a fourth TB and a PUCCH resource indicator, which may be the same as the third PUCCH resource indicator. The UE 102 descrambles the DCI 4 using the G-RNTI 2 and receives 468A the fourth TB for the second MBS service in accordance with the DCI 4.

If the UE 102 successfully receives and decodes the fourth TB, the UE 102 can transmit an ACK to the base station 104, similar to the ACK the UE 102 transmits 340B. Otherwise, as in the scenario 400A, the UE 102 transmits 472A a NACK to the fourth TB on the third PUCCH resource. The base station 104 determines that the NACK is for the second MBS service because the base station 104 previously transmitted 426A the MBS interest confirm message to the UE 102. The base station 104 can then transmit 474A a DCI 5 for a retransmission of the fourth TB. The base station 104 may transmit 474 the DCI 5 with the G-RNTI (i.e., in broadcast or multicast) or with a C-RNTI for the UE 102 (i.e., in unicast). If the UE 102 successfully receives 476A the fourth TB from the base station 104, the UE 102 can transmit 480A an ACK to the fourth TB on the fourth PUCCH resource, in accordance with the DCI 5.

Events 460A, 466A, 468A, 472A, 474A, 476A, and 478A are collectively referred to in this disclosure as a second MBS service reception procedure 480A.

Referring next to FIG. 4B, a scenario 400B is generally similar to the scenario 400A, except that the UE 102 stops 453B monitoring for DCIs with the G-RNTI 1 and also does not start monitoring for DCIs with the G-RNTI 2 after determining 422B that the UE 102 is interested in receiving a second MBS service. Accordingly, although the base station 104 may broadcast 430B a DCI 1 and 437B a DCI2, the UE 102 skips receiving both the DCI 1 and the DCI 2. Thus, the UE 102 receives neither the first MBS service nor the first MBS service after determining 422C to switch to the second MBS service and before receiving an MBS interest confirm message. After receiving 426B an MBS interest confirm message in response to the MBS interest information message that the UE 102 transmits 424B, the UE 102 starts 428B monitoring for DCIs with the G-RNTI 2. Because the UE 102 has received 426B the MBS interest confirm message, the UE 102 also starts 428B reporting HARQ feedback for the second MBS service. The UE 102 then receives 480B the second IBS service from the base station 104.

Referring next to FIG. 4C, a scenario 400C is generally similar to the scenario 400A, except that the UE 102 continues 454C to monitor for DCIs with the G-RNTI 1 in addition to starting 454C monitoring for DCIs with the G-RNTI 2 after determining 422C to switch to the second MBS service. Thus, the UE 102 may receive both the first MBS service and the second MBS service before receiving an interest confirm message. However, the UE 102 does not providing HARQ feedback for the second MBS service if the UE 102 has not received an MBS interest confirm message. Accordingly, the UE 102 may receive 431C the DCI 1, receive 433C a first TB in accordance with the DCI 1, receive 436C the DCI 2, and receive 438C a second TB in accordance with the DCI 2. While the UE 102 transmits 435C an ACK to the first TB on the first PUCCH resource, the UE 102 does not transmit an ACK or NACK to the second TB.

After receiving 426C an MBS interest confirm message in response to the MBS interest information message the UE 102 transmits 424C, the UE 102 stops 429C monitoring DCIs with the G-RNTI 2 and starts 429C reporting HARQ feedback for the second MBS service. The UE 102 then receives 480C the second MBS service from the base station 104.

In some alternative scenarios, while the UE 102 continues 454C to monitor for DCIs with the G-RNTI 1, the UE 102 may skip receiving TBs at the resources indicated by the DCIs with the G-RNTI 1. For example, the UE 102 may receive 431C the DCI 1, but may skip receiving 433C the first TB. The UE 102 may still send either a NACK or an ACK to the first TB on the first PUCCH resource.

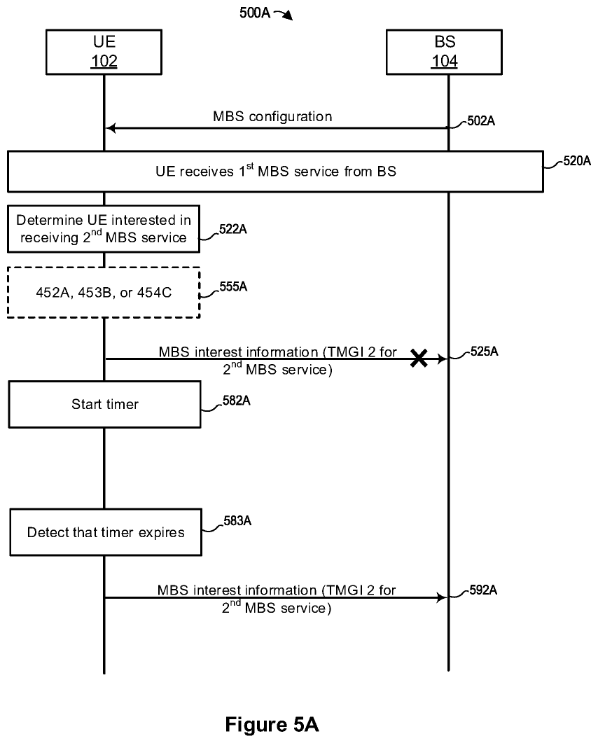

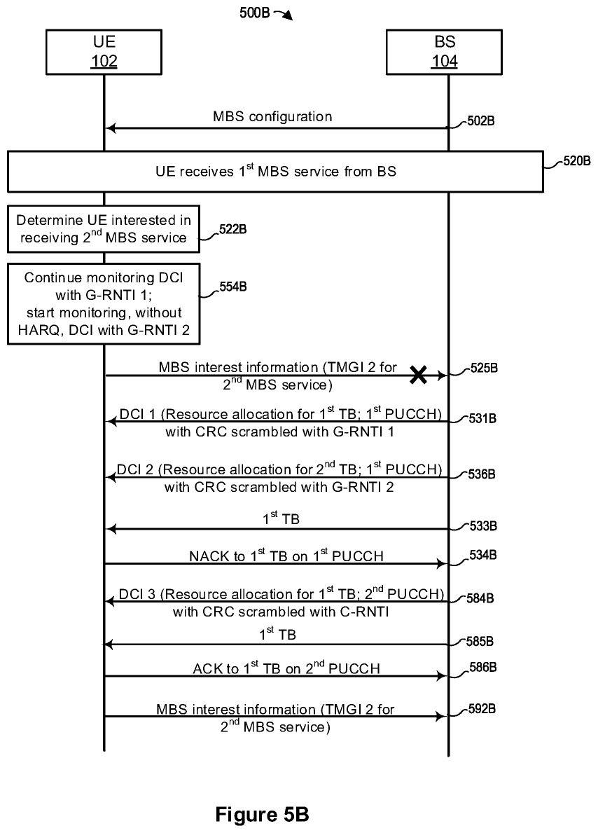

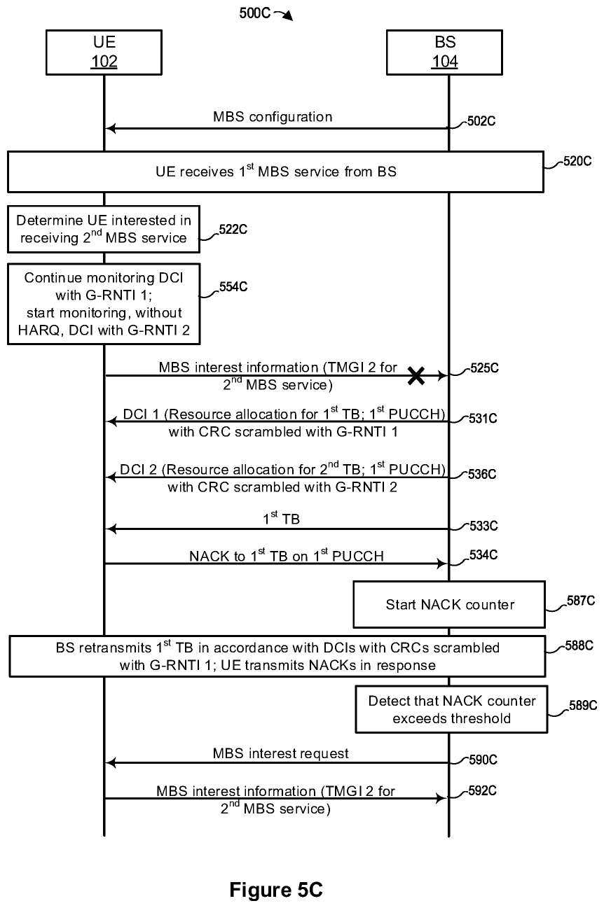

Referring next to FIGS. 5A-5C, in some scenarios, the base station 104 may fail to receive the IBS interest information message, or otherwise may fail to transmit an IBS interest confirm message to the UE 102. FIGS. 5A-5C illustrate ways in which the UE 102 can determine to retransmit the IBS interest information message.

FIG. 5A illustrates a scenario 500A, which may begin similarly to the scenarios 300A-C and 400A-C. After receiving 520A a first MBS service, the UE 102 determines 522A that the UE 102 is interested in receiving a second MBS service. The UE 102 attempts 525A to transmit an MBS interest information message including the TMGI 2 to the base station 104. However, the base station 104 fails 525A to receive the MBS interest information message. Further, the UE 102 may handle 555A messages received after determining 522A to receive the second MBS service and before receiving an MBS interest confirm message using any of the techniques discussed with reference to FIGS. 4A-4C (i.e., by utilizing any one of the behaviors 452A, 453B, or 454C).

Upon transmitting 525A the MBS interest information message to the base station 104, the UE 102 starts 582A a timer. The timer may expire after a predetermined time period. If the UE 102 detects 583A that the timer expires prior to receiving an MBS interest confirm message, then the UE 102 retransmits 592A the MBS interest information message including the TMGI 2 to the base station 104. After retransmitting 592A the MBS interest information message, the UE 102 may restart the timer.

Referring next to FIG. 5B, a scenario 500B also begins similarly to the scenarios 300A-C and 400A-C. After receiving 520B a first MBS service, the UE 102 determines 522B that the UE 102 is interested in receiving a second MBS service. The UE 102 attempts 525B to transmit an MBS interest information message including the TMGI 2 to the base station 104. However, the base station 104 fails 525B to receive the MBS interest information message. Further, the UE 102 may continue 554B to monitor for DCIs with the G-RNTI 1 and start 554B to monitor DCIs with the G-RNTI 2 without providing HARQ feedback for the second MBS service, as in the scenario 400C. The UE 102 receives 531B a DCI 1 with the G-RNTI 1 and receives 536B a DCI2 with the G-RNTI 2. In accordance with the DCI 1, the UE 102 receives 533B a first TB for the first MBS service. However, to indicate that the UE 102 is no longer interested in receiving the first MBS service, the UE 102 transmits 534B a NACK to the first TB on the first PUCCH. The base station 104, having not received 525B the MBS interest information, retransmits the first TB to the UE 102 in unicast (i.e., by transmitting 584B a DCI 3 with a C-RNTI to the UE 102 and transmitting 585B the first TB to the UE 102 in accordance with the DCI 3). The UE 102 may transmit 586B an ACK to the first TB on the second PUCCH resource indicated by the DCI 3. In response to receiving the first TB in unicast, the UE 102 can determine that the base station 104 did not successfully receive the MBS interest information message. Accordingly, the UE 102 retransmits 592B the MBS interest information message including the TMGI 2 to the base station 104.

While FIG. 5B illustrates the UE 102 as continuing 554B to monitor for DCIs with the G-RNTI 1, similar to how the UE 102 continues 454C to monitor for DCIs with the G-RNTI 1, the UE 102 and the base station 104 may also apply the techniques of FIG. 5B in scenarios where the UE 102 stops monitoring for DCIs with the G-RNTI (e.g., as in events 452A and 453B). In particular, if the base station 104 broadcasts the DCI 1 and does not receive an ACK or an explicit NACK for the first TB from the UE 102, the base station 104 can treat the lack of ACK or NACK as a NACK. The base station 104 can then retransmit the first TB in unicast to the UE 102, and the scenario can proceed with the events 584B, 585B, 586B, and 592B.

Referring next to FIG. 5C, a scenario 500C begins similarly to the scenario 500B. After receiving 534C the NACK from the UE 102, the base station 104 starts 587C a NACK counter. The base station 104 retransmits 588C the first TB to the UE 102 (e.g., by transmitting DCIs with the G-RNTI 1 to the UE 102 and retransmitting the first TB in accordance with the DCIs), and the UE 102 responds with a NACK. The base station 104 may repeatedly attempt to retransmit 588C the first to the UE 102, and the UE 102 responds to each retransmission with a NACK. Each time the base station 104 receives a NACK for the first TB, the base station 102 can add a NACK to the NACK counter. If base station 104 detects 589C that the NACK counter exceeds a predetermined threshold (e.g., the NACK counter exceeds a threshold of N), the base station 104 can determine that the UE 102 may have changed its interest in the first MBS service. To determine the updated interest of the UE 102, the base station 104 transmits 590C an MBS interest request to the UE 102. In response, the UE 102 retransmits 592C the MBS interest information including the TMGI 2 to the base station 104.

While FIG. 5C illustrates the UE 102 as continuing 554C to monitor for DCIs with the G-RNTI 1, similar to how the UE 102 continues 454C to monitor for DCIs with the G-RNTI 1, the UE 102 and the base station 104 may also apply the techniques of FIG. 5C in scenarios where the UE 102 stops monitoring for DCIs with the G-RNTI (e.g., as in events 452A and 453B). In particular, if the base station 104 broadcasts the DCI 1 and does not receive an ACK or an explicit NACK for the first TB from the UE 102, the base station 104 can treat the lack of ACK or NACK as a NACK. The base station 104 can then start 587C a NACK counter, and the scenario can proceed with the events 588C, 589C, 590C, and 592C.

Referring next to FIGS. 6A-6D, the UE 102 may be capable of consuming multiple IBS services concurrently.

In a scenario 600A illustrated by FIG. 6A, the UE 102 initially acquires information related to MBS services (e.g., service broadcasting time, frequency band, broadcast area, etc.) from USD metadata. In the scenario 600A, the USD describes at least three MBS services: a first MBS service, a second MBS service, and a third MBS service. Further, the USD includes TMGIs 1-3 identifying the first, second, and third IBS services, respectively. The base station 104 may broadcast or multicast the first, second, and third MBS services concurrently. Further, the UE 102 is capable of receiving the first, second, and third MBS services concurrently. To receive the three IBS services concurrently, the UE 102 can receive overlapping streams of TBs (i.e., the UE 102 can receive a first TB for the first MBS service, a second TB for the second MBS service, a third TB for the first MBS service, and then a fourth TB for the third MBS service. The base station 104 can schedule TBs for concurrent services by time division multiplexing (TDM), frequency division multiplexing (FDM), or spatial division multiplexing (SDM) methods). In some implementations, the UE 102 may have multiple antennas capable of receiving the three MBS services at the same time.

The base station 104 transmits 602A MBS configuration information (e.g., SC-PTM configuration information) to the UE 102. In the MBS configuration information, the base station 104 includes G-RNTIs 1-3 and indicates that the G-RNTIs 1-3 are associated with the TMGIs 1-3, respectively.

To receive the three MBS services, the UE 102 transmits 604A an MBS interest information message to the base station 104 that includes the TMGIs 1-3. Further, in the MBS interest information message, the UE 102 can indicate information related to the MBS services. For example, the UE 102 can indicate the priority of each TMGI (e.g., using a new field or by using the order of TMGIs in the interest information message), whether the UE 102 supports HARQ for each MBS service, and/or a range of HARQ process IDs that the UE 102 supports for each MBS service. Based on the MBS interest information message, the base station 104 determines that the UE 102 is interested in receiving the three IBS services. In response, the base station 104 transmits 606A an MBS interest confirm message to the UE 102. As discussed in reference to FIGS. 3A-5C, after receiving the MBS interest confirm message, the UE 102 starts to report HARQ feedback for the MBS services.

To transmit the MBS services to the UE 102, the base station 104 transmits 608A a DCI 1 to the UE 102 with the G-RNTI 1. The DCI 1 includes a resource allocation for a first TB for the first MBS service and a first PUCCH resource indicator. Similarly, the base station 104 transmits 610A a DCI 2 and transmits 612A a DCI 3 to the UE 102 with the G-RNTI 2 and the G-RNTI 3, respectively. The DCI 2 and the DCI 3 may include the same PUCCH resource indicator as the DCI 1 (i.e., the first PUCCH resource indicator). The base station 104 then transmits 614A, 616A, 618A the first TB, second TB, and third TB to the UE 102 for the first, second, and third MBS services, respectively.

Events 602A, 604A, 606A, 608A, 610A, 612A, 614A, 616A, and 618A are collectively referred to in this disclosure as a parallel MBS reception procedure 620A.

The UE 102 can then provide HARQ feedback for the three MBS services. In some implementations, the UE 102 can multiplex HARQ feedbacks for the different MBS services on the same PUCCH or PUSCH resource based on the received DCIs and/or based on whether the UE 102 supports HARQ for the services (as indicated in the MBS interest information message). The UE 102 can multiplex the HARQ feedbacks in a HARQ codebook. In some implementations, the base station 104 may configure a range of HARQ process IDs for one or more of the MBS services based on the information received 604A in the MBS interest information message. The base station 104 can indicate the ranges of HARQ process IDs in MBS configuration information, the MBS interest confirm message, or another message (e.g., an RRC message or a MAC control element).

In the scenario 600A, the UE 102 fails to successfully decode the first TB and the second TB and successfully decodes the third TB. Accordingly, the UE 102 transmits 622A to the base station 104 NACKs for the first and second TB and an ACK for the third TB. The UE 102 can transmit the two NACKs and the ACK multiplexed together on the same first PUCCH resource. Depending on the implementation, the UE 102 may transmit 622A the HARQ feedback for the MBS services in accordance with the information that the UE 102 transmits 604A in the MBS interest information message and/or receives 606A in the MBS interest confirm message (e.g., the priority of the MBS services, whether the UE 102 supports HARQ feedback for the MBS services, the range of HARQ process IDs provided by the base station 104 (if any), etc.).

In response to the NACK to the first TB, the base station 104 can retransmit the first TB via broadcast or unicast. In particular, the base station 104 can transmit 625A a DCI 4, including a resource allocation for the first TB and a second PUCCH resource indicator, with the G-RNTI 1 (for broadcast) or a C-RNTI (for unicast) and transmit 636A the first TB in accordance with the DCI 4. Likewise, the base station can transmit 630A a DCI 5, including a resource allocation for the second TB and a third PUCCH resource indicator, with the G-RNTI 2 (for broadcast) or a C-RNTI (for unicast) and transmit 638A the second TB in accordance with the DCI 5. If the UE 102 successfully receives and decodes the first and the second TBs, the UE 102 transmits 640A, 642A ACKs to the first TB and the second TB on the second PUCCH resource and the third PUCCH resource, respectively.

The events 636A, 638A, 640A, and 642A are collectively referred to herein as a parallel MBS services retransmission procedure 650A.

If the base station 104 transmits the first TB and the second TB both in unicast (i.e., in accordance with DCIs scrambled with the C-RNTI of the UE 102), and the retransmissions are both mapped to the same HARQ process ID, the UE 102 may be unable to distinguish whether the received first TB is for the first MBS service or the second MBS service (and similarly may be unable to distinguish whether the received second TB is for the first MBS service or the second MBS service). Such a scenario may occur because there HARQ process ID ranges for the first and the second MBS services may overlap. As a result, the DCI 4 and the DCI 5 may configure the retransmissions with the same HARQ process ID. FIGS. 6B-6D illustrate techniques which the UE 102 and/or the base station 104 may utilize to avoid this HARQ collision scenario.

Referring to FIG. 6B, a scenario 600B is similar to the scenario 600A, except that the base station 104 avoids a HARQ collision scenario by retransmitting in unicast only one MBS service of concurrent MBS services sharing the same HARQ ID. The UE 102 transmits 622B to the base station 104 NACKs to the first TB and the second TB and an ACK to the third TB. The base station 104 determines 623B which of the first MBS service or the second MBS service to retransmit in unicast. In some scenarios, such as the scenario 600B, the base station 104 determines 623B to retransmit the first MBS service in unicast in response to determining that the first MBS service has the highest priority for the UE 102. The UE 102 can indicate the priority of each MBS service in the MBS interest information message. Additionally or alternatively, the base station 104 may use other criteria to determine 623B which MBS service to retransmit in unicast, such as the order of the TMGIs, or the comparative DCI timing of the initial transmissions.

In other scenarios, the base station 104 indicates whether the base station 104 supports HARQ for the MBS services in the MBS configuration information. For example, the MBS configuration information can indicate that the first MBS service and the second MBS service are supported with HARQ, but that the third MBS service is not. The UE 102 may only be allowed to receive one MBS service for which HARQ is supported. Accordingly, the UE 102 can include in the MBS interest information message TMGIs 1 and 3 or TMGIs 2 and 3, but not both TMGIs 1 and 2. In other words, the UE 102 is only allowed to choose one MBS service with HARQ support. The base station 104 can determine 623B to retransmit in unicast the MBS service with HARQ support.

After determining 623B to transmit the first MBS service in unicast, the base station 104 transmits 626B a DCI 4 for the first TB with a C-RNTI for the UE 102. The base station 104 can also transmit 631B a DCI 5 for the second TB, but uses the G-RNTI 2 to scramble the CRC for the DCI 5. The base station 104 can then retransmit 650B the first and second TBs to the UE 102 in accordance with the DCI 4 and the DCI 5, respectively.

Referring to FIG. 6C, a scenario 600C is similar to the scenario 600A, except that the base station 104 avoids a HARQ collision scenario by including a field (also referred to herein as an information element) the DCI that indicates the associated MBS service. In particular, the base station 104 transmits 627C a DCI 4 to the UE 102 including a field set to a value that indicates that the first TB is for the first MBS service. Similarly, the base station 104 transmits 632C a DCI 5 to the UE 102 including the field set to a value that indicates that the second TB is for the second MBS service. The field may indicate the TMGI for the first MBS service. For example, if there are two parallel MBS services that the base station 104 supports with HARQ (i.e., the first MBS service and the second MBS service), then the base station 104 can set the field in the DCI 4 to “0” to indicate that the retransmission is for the TMGI 1. Similarly, the base station 104 can set the field in the DCI 5 to “1” to indicate that the retransmission is for the TMGI 2. In other words, different values of the field indicate different MBS services, respectively, of the MBS services with a TMGI included in the MBS interest information message. In some implementations, the base station 104 can use the field to indicate retransmission of broadcast and unicast services. Further, the base station 104 can retransmit both the first TB and the second TB in unicast because the UE 102 will be able to distinguish the MBS services based on the values of the field in the DCIs.

Referring to FIG. 6D, a scenario 600D is similar to the scenario 600A, except that the base station 104 avoids a HARQ collision scenario by calculating slot indices for the retransmissions in accordance with a formula known by both the base station 104 and the UE 102. In particular, after receiving 622D the NACKs to the first TB and the second TB, the base station 104 can use the formula to calculate slot indices (e.g., PDCCH or PDSCH slot indices) for scheduling or retransmission of the first and the second TBs. The base station 104 transmits 628D a DCI 4 for the first TB with the C-RNTI of the UE 102, and transmits 633D a DCI 5 for the second TB with the C-RNTI. The DCIs 4 and 5 indicate the slot indices (i.e. time and/or frequency resource allocations) for scheduling or transmission of the first and second TBs calculated using the formula. The UE 102 can also calculate the slot indices using the formula, and therefore can determine, based on the slot indices allocated for the first TB and the second TB, which slot index corresponds to which TB.

As one example, in a frequency division duplex (FDD) system, if the number of parallel MBS services included in the MBS interest information message is X, and the retransmitted TB is for the Y^{th} service included in the MBS interest information message, the base station 104 can retransmit the TB on slots with index Z in accordance with the following formula:

Y=Z modulo X

In the scenario 600D, the number of parallel MBS services X=3. For the first MBS service, Y=0. For the second MBS service, Y=1. Allowed slot indices for the first MBS service are those slot indices Z such that Z modulo 3=0 (i.e., slot indices 0, 3, 6, etc.). Allowed slot indices for the second MBS service are those slot indices Z such that Z modulo 3=1 (i.e., slot indices 1, 4, 7, etc).

In some implementations, the formula may take into account an offset:

Y=Z modulo X+offset

The slot index may be accumulated over multiple system frames (e.g., calculated based on a system frame number (SFN)).

As another example, in a time division duplex (TDD) system, the base station 104 may use one of the example formulas above to calculate the slot index, where the slot index indicates the index of each system frame.

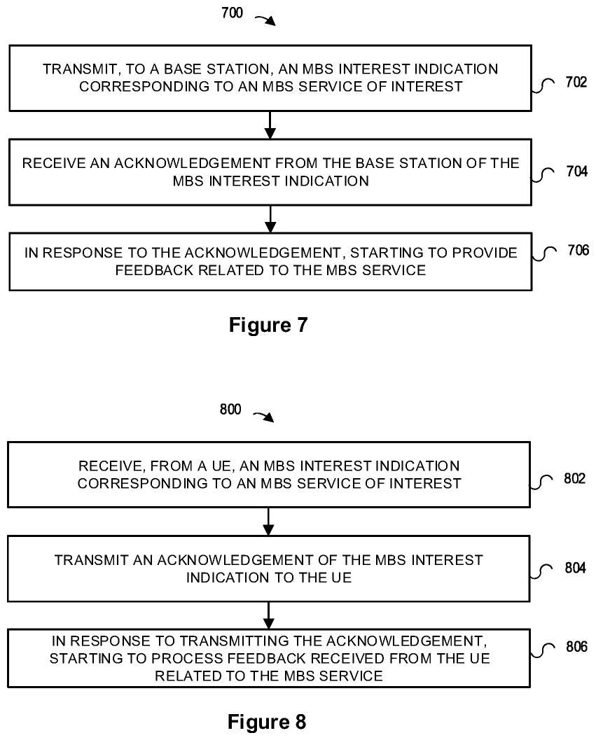

FIG. 7 is a flow diagram of an example method 700 for managing reception of MBS, which can be implemented in a UE (e.g., the UE 102). At block 702, the UE transmits, to a base station (e.g., the base station 104), an MBS interest indication (e.g., an MBS interest information message) corresponding to an MBS service of interest (e.g., events 304A, 324B-C, 424A-C, 525A-C, 592A-C, or 604A, or similar events within the procedures 320B-C, 420A-C, 520A-C, or 620A-D). At block 704, the UE receives an acknowledgement (e.g., an MBS interest confirm message) from the base station of the MBS interest indication (e.g., events 306A, 326B-C, 426A-C, or 606A, or similar events within the procedures 320B-C, 420A-C, 520A-C, or 620A-D). In response to the acknowledgement, the UE at block 706 starts to provide feedback related to the MBS service (e.g., events 308A, 327B-C, 427A, 428B, or 429C, or similar events within the procedures 320B-C, 420A-C, 520A-C, or 620A-D).

FIG. 8 is a flow diagram of an example method 800 for managing transmission of MBS, which can be implemented in a base station (e.g., the base station 104). At block 802, the base station receives, from a UE (e.g., the UE 102), an MBS interest indication (e.g., an MBS interest information message) corresponding to an MBS service of interest (e.g., events 304A, 324B-C, 424A-C, 525A-C, 592A-C, or 604A, or similar events within the procedures 320B-C, 420A-C, 520A-C, or 620A-D). At block 804, the base station transmits an acknowledgement of the MBS interest indication (e.g., an MBS interest confirm message) to the UE (e.g., events 306A, 326B-C, 426A-C, or 606A, or similar events within the procedures 320B-C, 420A-C, 520A-C, or 620A-D). In response to transmitting the acknowledgement, the UE at block 806 starts to process feedback received from the UE related to the MBS service (i.e., the base station processes feedback received on PUCCH resources allocated for the UE as related to the MBS service).

The following list of examples reflects a variety of the embodiments explicitly contemplated by the present disclosure:

Example 1. A method in a user equipment (UE) for managing reception of multicast and/or broadcast services (MBS), the method comprising: transmitting, by a processing hardware of the UE to a base station, an MBS interest indication corresponding to an MBS service of interest; receiving, by the processing hardware from the base station, an acknowledgement of the MBS interest indication; and in response to the acknowledgement, starting, by the processing hardware, to provide feedback related to the MBS service.

Example 2. The method of example 1, further comprising: monitoring, by the processing hardware, for downlink control information for the MBS service prior to receiving the acknowledgement; and receiving, by the processing hardware, data for the MBS service in accordance with the downlink control information.

Example 3. The method of example 1, further comprising: monitoring, by the processing hardware, for downlink control information for the MBS service in response to receiving the acknowledgement; and receiving, by the processing hardware, data for the MBS service in accordance with the downlink control information.

Example 4. The method of any one of examples 2 or 3, wherein monitoring for the downlink control information for the MBS service includes monitoring for the downlink control information including an attachment scrambled with an identifier of the MBS service.

Example 5. The method of any one of examples 1-4, wherein: the MBS service is a first MBS service; and the method further comprises: transmitting, by the processing hardware, a second MBS interest indication corresponding to a second MBS service of interest; and monitoring, by the processing hardware, for downlink control information for the first MBS service after transmitting the second MBS interest indication.

Example 6. The method of example 5, further comprising: receiving, by the processing hardware, a second acknowledgement of the second MBS interest indication; and stopping, by the processing hardware, the monitoring in response to receiving the second acknowledgement.

Example 7. The method of any one of examples 1-4, wherein: the MBS service is a first MBS service; and the method further comprises: monitoring, by the processing hardware, for downlink control information for the first MBS service; transmitting, by the processing hardware, a second MBS interest indication corresponding to a second MBS service of interest; and prior to receiving a second acknowledgement of the second MBS interest indication, stopping the monitoring.

Example 8. The method of any one of the previous examples, further comprising: determining, by the processing hardware, that the UE has not received the acknowledgement within a predetermined time period after transmitting the MBS interest indication; and retransmitting, by the processing hardware, the MBS interest indication to the base station in response to the determining.

Example 9. The method of any one of examples 1-4, wherein: the MBS service is a first MBS service; and the method further comprises: transmitting, by the processing hardware, a second MBS interest indication corresponding to a second MBS service of interest; and transmitting, by the processing hardware, a negative acknowledgement of data packets of the first MBS service to the base station after transmitting the second MBS interest indication.

Example 10. The method of example 9, further comprising receiving, by the processing hardware, a unicast retransmission of the data packets from the base station; and retransmitting, by the processing hardware, the second MBS interest indication to the base station in response to receiving the unicast retransmission.

Example 11. The method of example 9, further comprising: receiving, by the processing hardware, an MBS interest request from the base station; and retransmitting, by the processing hardware, the MBS interest indication to the base station in response to receiving the MBS interest request.

Example 12. The method of example 1, wherein the MBS interest indication indicates two or more MBS services that the UE is interested in receiving concurrently.

Example 13. The method of example 12, further comprising: transmitting, by the processing hardware, acknowledgements for the two or more MBS services to the base station on a shared uplink resource.

Example 14. The method of any one of examples 12 or 13, further comprising: receiving, by the processing hardware, a retransmission of at least one MBS service of the two or more MBS services; identifying, by the processing hardware, to which of the two or more MBS services the retransmission corresponds by determining whether the base station transmitted the retransmission to the UE as a unicast retransmission.

Example 15. The method of example 14, wherein determining whether the base station transmitted the retransmission as a unicast retransmission includes: receiving, by the processing hardware, downlink control information indicating the retransmission; and determining, by the processing hardware, that that downlink control information includes an attachment scrambled with an identifier of the UE.

Example 16. The method of any one of examples 12 or 13, further comprising: receiving, by the processing hardware, downlink control information indicating a retransmission of at least one MBS service, the downlink control information including an information element indicating that the retransmission corresponds to a particular MBS service of the two or more MBS services.

Example 17. The method of any one of examples 12 or 13, further comprising: receiving, by the processing hardware, downlink control information indicating a retransmission of at least one MBS service at a time resource and/or a frequency resource; calculating, by the processing hardware, to which of the two or more MBS services the retransmission corresponds based on (i) the time resource and/or the frequency resource and (ii) a number of MBS services that the UE is concurrently receiving.

Example 18. A user equipment (UE) including processing hardware and configured to implement a method according to any one of examples 1-17.

Example 19. A method in a base station for managing transmission of multicast and/or broadcast services (MBS), the method comprising: receiving, by a processing hardware of the base station from a UE, an MBS interest indication corresponding to an MBS service of interest; transmitting, by the processing hardware to the UE, an acknowledgement of the MBS interest indication; and in response to transmitting the acknowledgement, starting, by the processing hardware, to process feedback received from the UE related to the MBS service.

Example 20. The method of example 19, further comprising: transmitting, by the processing hardware, downlink control information for the MBS service to the UE, the downlink control information including an attachment scrambled with an identifier of the MBS service.

Example 21. The method of any one of examples 19 or 20, wherein: the MBS service is a first MBS service; the acknowledgement is a first acknowledgment; and the method further comprises: receiving, by the processing hardware, a second MBS interest indication corresponding to a second MBS service of interest; receiving, by the processing hardware, first feedback from the UE related to the first MBS service or the second MBS service; and if the first feedback is received prior to transmitting a second acknowledgement of the second MBS interest indication, determining that the first feedback is related to the first MBS service.

Example 22. The method of any one of examples 19 or 20, wherein: the MBS service is a first MBS service; the acknowledgement is a first acknowledgment; and the method further comprises: receiving, by the processing hardware, a second MBS interest indication corresponding to a second MBS service of interest; transmitting, by the processing hardware, a second acknowledgement of the second MBS interest indication; receiving, by the processing hardware, first feedback from the UE related to the first MBS service or the second MBS service; and if the first feedback is received after transmitting the second acknowledgement, determining that the first feedback is related to the second MBS service.

Example 23. The method of example 19, further comprising: transmitting, by the processing hardware, data for the MBS service to the UE; receiving, by the processing hardware, a negative acknowledgement of the data from the UE; repeating the transmitting of the data and the receiving of the negative acknowledgement N times; in response to determining that N exceeds a predetermined number, transmitting, by the processing hardware, a request for the UE to indicate the MBS services in which the UE is interested.

Example 24. The method of example 19, wherein the MBS interest indication indicates two or more MBS services that the UE is interested in receiving concurrently.

Example 25. The method of example 24, further comprising: transmitting, by the processing hardware, first data for a first MBS service of the two or more MBS services; transmitting, by the processing hardware, second data for a second MBS service of the two or more MBS services; receiving, by the processing hardware, negative acknowledgements to the first data and the second data from the UE.

Example 26. The method of example 25, wherein receiving the negative acknowledgements includes receiving the negative acknowledgements on a shared uplink resource.

Example 27. The method of any one of examples 25 or 26, further comprising: retransmitting, by the processing hardware, the first data or the second data in unicast to the UE based on whether the first MBS service or the second MBS service has a higher priority.

Example 28. The method of example 27, wherein retransmitting the first data or the second data in unicast includes: transmitting, by the processing hardware, downlink control information for the first data or the second data including an attachment scrambled with an identifier of the UE; and retransmitting, by the processing hardware, the first data or the second data in accordance with the downlink control information.

Example 29. The method of any one of examples 25 or 26, further comprising: transmitting, by the processing hardware, downlink control information indicating a retransmission of the first data, the downlink control information including an information element indicating that the retransmission corresponds to the first MBS service.

Example 30. The method of any one of examples 25 or 26, further comprising: calculating, by the processing hardware, a time resource and/or a frequency resource on which to retransmit the first data based on a number of MBS services that the UE is concurrently receiving; transmitting, by the processing hardware, downlink control information indicating a retransmission of the first data at the time resource and/or the frequency resource.

Example 31. A base station including processing hardware and configured to implement a method according to any one of examples 19-30.

The following additional considerations apply to the foregoing discussion.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional alternative structural and functional designs for feedback mechanisms for MBS through the disclosed principles herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1. A method implemented in a user equipment (UE) for managing reception of multicast and/or broadcast services (MBS), the method comprising:
transmitting, to a base station, an MBS interest indication corresponding to an MBS service of interest;
receiving, by the processing hardware from the base station, an acknowledgement of the MBS interest indication; and
monitoring for downlink control information for the MBS service; and
receiving data packets for the MBS service in accordance with the downlink control information.

2. The method of claim 1,
wherein the monitoring for downlink control information for the MBS service occurs prior to receiving the acknowledgement.

3. The method of claim 1,
wherein the monitoring for downlink control information for the MBS service occurs in response to receiving the acknowledgement.

4. The method of claim 1, wherein:
the MBS service is a first MBS service; and
the method further comprises:
transmitting a second MBS interest indication corresponding to a second MBS service of interest; and
monitoring for downlink control information for the first MBS service after transmitting the second MBS interest indication.

5. The method of claim 4, further comprising:
receiving a second acknowledgement of the second MBS interest indication; and
stopping the monitoring in response to receiving the second acknowledgement.

6. The method of claim 1, wherein:
the MBS service is a first MBS service; and
the method further comprises:
monitoring for downlink control information for the first MBS service;
transmitting a second MBS interest indication corresponding to a second MBS service of interest; and
prior to receiving a second acknowledgement of the second MBS interest indication, stopping the monitoring.

7. The method of claim 1, wherein:
the MBS service is a first MBS service; and
the method further comprises:
transmitting a second MBS interest indication corresponding to a second MBS service of interest; and
transmitting a negative acknowledgement of data packets of the first MBS service to the base station after transmitting the second MBS interest indication.

8. The method of claim 7, further comprising
receiving a unicast retransmission of the data packets of the first MBS service from the base station; and
retransmitting the second MBS interest indication to the base station in response to receiving the unicast retransmission.

9. The method of claim 7, further comprising:
receiving an MBS interest request from the base station; and
retransmitting the MBS interest indication to the base station in response to receiving the MBS interest request.

10. A user equipment (UE) including processing hardware and configured to:
transmit, to a base station, an MBS interest indication corresponding to an MBS service of interest;
monitor for downlink control information for the MBS service; and
receive data packets for the MBS service in accordance with the downlink control information.

11. A method in a base station for managing transmission of multicast and/or broadcast services (MBS), the method comprising:
receiving from a UE, an MBS interest indication corresponding to an MBS service of interest;
transmitting downlink control information for the MBS service to the UE, the downlink control information including an attachment scrambled with an identifier of the MBS service; and
transmitting to the UE, an acknowledgement of the MBS interest indication.

12. The method of claim 11, further comprising:
transmitting downlink control information for the MBS service to the UE, the downlink control information including an attachment scrambled with an identifier of the MBS service.

13. The method of claim 11, wherein:
the MBS service is a first MBS service;
the acknowledgement is a first acknowledgment; and
the method further comprises:
receiving a second MBS interest indication corresponding to a second MBS service of interest;
transmitting a second acknowledgement of the second MBS interest indication;
receiving first feedback from the UE related to the first MBS service or the second MBS service; and
after receiving the first feedback:
in a first instance, if the first feedback is received after transmitting the second acknowledgement, determining that the first feedback is related to the second MBS service; and
in a second instance, if the first feedback is received before transmitting the second acknowledgement, determining that the first feedback is related to the first MBS service.

14. The method of claim 11, wherein:
the MBS interest indication indicates two or more MBS services that the UE is interested in receiving concurrently;
the method further comprises:
transmitting first data for a first MBS service of the two or more MBS services;
transmitting second data for a second MBS service of the two or more MBS services; and
receiving negative acknowledgements to the first data and the second data from the UE on a shared uplink resource.

15. (canceled)

16. The UE claim 10, further configured to:
monitor downlink control information for the MBS service prior to receiving the acknowledgement.

17. The UE claim 10, further configured to:
monitor downlink control information for the MBS service in response to receiving the acknowledgement.

18. The UE claim 10, wherein:
the MBS service is a first MBS service; and
the UE is further configured to:
transmit a second MBS interest indication corresponding to a second MBS service of interest; and
monitor for downlink control information for the first MBS service after transmitting the second MBS interest indication.

19. The UE of claim 18, further configured to:
receive second acknowledgement of the second MBS interest indication; and
stop the monitoring in response to receiving the second acknowledgement.

20. The UE claim 10, wherein:
the MBS service is a first MBS service; and
the UE is further configured to:
monitor for downlink control information for the first MBS service;
transmit a second MBS interest indication corresponding to a second MBS service of interest; and
prior to receiving a second acknowledgement of the second MBS interest indication, stop the monitoring.

21. The UE claim 10, wherein:
the MBS service is a first MBS service; and
the UE is further configured to:
transmit a second MBS interest indication corresponding to a second MBS service of interest; and
transmit a negative acknowledgement of data packets of the first MBS service to the base station after transmitting the second MBS interest indication.
